(19) United States
(12) Patent Application Publication
(10) Pub. No.: US 2012/0058348 A1
(43) Pub. Date: Mar. 8, 2012

(54) ANTI-FUEL-LEAK BARRIER COATING AND METHODOLOGY FEATURING CAST LAYER STRUCTURE

(75) Inventors: Russell A. Monk, Salem, OR (US); Thomas S. Ohnstad, Salem, OR (US)

(73) Assignee: High Impact Technology, L.L.C., Tigard, OR (US)

(21) Appl. No.: 13/218,350

(22) Filed: Aug. 25, 2011

Related U.S. Application Data
(60) Provisional application No. 61/380,224, filed on Sep. 4, 2010.

(51) Int. Cl. B32B 27/06; B05D 1/36

(52) U.S. Cl. 428/423.3; 427/407.1

(57) ABSTRACT

An anti-fuel-leak, plural-layer barrier coating applicable to the outside surface of the wall in a liquid-fuel container possessing a layer stack including plural, cooperating, barrier layers, each formed of a high-elastomeric material which reacts with a material-swelling behavior on contact with fuel of the type contained in the container, and, among these plural layers, at least one cast-formed layer. Associated methodology involves applying directly onto such a surface, by one only of the processes including casting and spraying, an inner layer formed of the mentioned high-elastomeric material, and thereafter forming, outwardly of the applied inner layer, and also of the same high-elastomeric material, another layer by the other one only of the two, mentioned processes. Selectively, the layer formed by spraying may include a population of spray-introduced, liquid-fuel imbiber beads

### CROSS REFERENCE TO RELATED APPLICATION

This application claims filing-date priority to U.S. Provisional Patent Application Ser. No. 61/380,234, filed Sep. 4, 2010, for “Anti-Fuel-Leak Barrier Coating and Methodology Featuring Cast Layer Structure”, the entire disclosure content in which is hereby incorporated herein by reference.

### BACKGROUND AND SUMMARY OF THE INVENTION

The present invention relates to a plural-layer, anti-fuel-leak barrier coating applicable to the outside of a liquid-fuel container, or tank, and to related, coating-formation methodology, which coating and methodology feature the presence and making of coating-included cast-formed layer structure. It should be understood that while the invention has special utility in terms of sealing a fuel leak initiated by a puncture wound in a fuel container, and the features of the invention are particularly described herein in the liquid fuel environment, the term “fuel” should be interpreted more broadly to include various other kinds of liquids.

Several U.S. patents provide useful background material in relation to understanding the features of this invention—these patents including U.S. Pat. Nos. 7,169,452, 7,220,455, 7,229,673, and 7,393,572. Accordingly, and for background reference purposes, the entire disclosure contents of these patents are hereby incorporated herein by reference.

In each of these background patents, barrier layer structures, or coatings, are described wherein plural layers are included, one of which, in addition to being formed with a body of fuel-reactive, high-elastomeric material, also includes a population of distributed fuel-imbiber beads. In all of these patents, each layer formed in each structure is specifically created as a spray-formed layer.

The present invention departs, at least in part, from this prior structure, and from the methodology associated with it (as presented in the mentioned patents), in the sense that, with regard to the present invention, a plural-layer barrier coating, which is generally like the coatings described in the patents, is proposed wherein the at least one of the layers is a cast-formed layer, i.e., a layer prepared by casting rather than by spraying.

There are many applications regarding which we have discovered that it is both useful, and important, to prepare plural-layer, and in many instances (though not all) specifically and preferably, three-layer, self-sealing, anti-puncture-leak coatings for, and applied to, the outsides of liquid-fuel containers, with these layers each featuring a combination of a sprayed-on and cast-in-place layers of an appropriate liquid-reactive, self-sealing, high-elastomeric material. Many of the applications in the past, generally speaking, for protective coatings constructed in relation to the functional nature just mentioned, such as those fully and variously described in the just-identified U.S. patents, have involved very large structures to be protected—structures such as a very large military fuel tankers, large, exposed fuel tanks and supply lines, large vehicle tanks, and so on. In these applications, spray-application of the appropriate, selected coating materials has been a logical and preferred route to follow in terms of applying particular coatings to such structures.

However, in all such environments, and in fact in substantially all kinds of installations involving spray-application processes, there always exists the issue of so-called overspray which is extremely difficult to control, and which, naturally by its nature, involves loss and waste of oversprayed material. This overspray matter becomes much more of a negative factor in relation to applying protective coatings of the character described to relatively small liquid-fuel containers, such as small vehicle fuel tanks. And, while there are several important reasons, even with such small structures, for continuing to utilize spray-application techniques for certain portions of layer coatings, or in certain special conditions, we have determined, as suggested above, that the employment of a combination of sprayed-on and cast-in-place coating layers makes very good sense, and indeed, introduces performance and application features and advantages that, as have later become apparent, are significant in their own right.

In addition to addressing quite successfully the above-mentioned overspray issue, casting, per se, of a layer in a protective coating of the type described turns out to offer some very special advantages in certain instances. For example, there are fuel tank, and like fuel-container, small structures which are shaped with intricate topographies, including complex surface regions which, because of something akin to underbeveling, or the like, include portions that are partially, or sometimes even rather fully, shaded against effective spray-application of a coating layer. Casting under such circumstances substantially completely solves this problem by virtue of the fact that cast material can be controlled so as to flow completely into, around and over such shaded areas to effect a protective coating layer which completely contacts the desired-to-be-protected surface areas in such a container.

There are also other kinds of instances wherein, notwithstanding careful preliminary topographic shaping of the outside surface configuration of a fuel tank so that the tank will best relate physically to its installation environment, spray-application of coating layers may so change the outside topographic features that they, and therefore the associated tank, no longer fit very well, or as preplanned, in an intended receiving environment. Here, cast application of an outside coating layer provides an approach wherein the outside topographic configuration of a finished, fully coated product may be given a very precise and even quite intricate outside topographic surface configuration which will match well in the zone wherein it is to be installed.

In all of the applications wherein we have found it desirable to combine spraying and casting as techniques for the formation of plural-layer protective coatings, our combinational approach, as set forth in the present invention disclosure text, intentionally retains employment of spray-application, especially involving the creation of an intermediate layer wherein it is desired to embed additional anti-leakage, self-sealing components, such as in the form of a distributed population of liquid-imbiber beads. Incorporation of such beads is most preferably accomplished in a pre-spray material-blending process, followed by spray application of thus blended material.

From the more detailed description of the invention which is presented hereinbelow, and through a reading and study of the included claims to invention, those skilled in the art will clearly appreciate how the layer-structure (referred to herein also as a layer stack, or layer-stack structure), and layer-application combinational, features of the present invention offer distinct advantages in many circumstances.

In the settings of these background, and new, invention-offered-advantage, considerations, here now are several ways, structural and methodologic, generally to express the nature of the present invention.

According to one such way, the invention, structurally, is an anti-fuel-leak, plural-layer barrier coating applicable to the outside surface of the wall in a liquid-fuel container, which coating, in operative condition relative to such a surface, includes (a) a layer stack including plural, cooperating, barrier layers, each formed of a high-elastomeric material which reacts with a material-swelling behavior on contact with fuel of the type contained in the container, and (b), among these layers, at least one cast-formed layer.

Another structural view of the invention sees it as an anti-fuel-leak, plural-layer barrier coating applicable to the outside surface of the wall in a liquid-fuel container, which coating, in operative condition relative to such a surface, includes (a) a layer stack including plural, cooperating, barrier layers, each formed of a high-elastomeric material which reacts with a material-swelling behavior on contact with fuel of the type contained in the container, and (b), among these layers, (1) at least one cast-formed layer, and (2), at least one spray-formed layer, wherein one of these two, so-called “at-least-one” layers is an inner layer disposed directly against the mentioned container-wall surface, and the other layer is an outer layer disposed outwardly of the inner layer relative to the container wall surface.

A further structural way of characterizing the present invention is to describe it as an anti-fuel-leak, plural-layer barrier coating having an inner side applicable to the outside surface of the wall in a liquid-fuel container, and an outer side, this coating, in operative condition relative to such a surface, possessing (a) cooperating, contact-adjacent layers, three in number, organized in at least one of the following manners, progressing from the inner side toward the outer side of the coating: (1) cast-formed, spray-formed, cast-formed; (2) spray-formed, spray-formed, cast-formed; and (3) cast-formed, spray-formed, spray-formed.

From a methodologic point of view, the invention features a method for creating an anti-fuel-leak, plural-layer-stack barrier coating on the outside surface of the wall in a liquid-fuel container including the steps of (a) applying directly onto such a surface, by one only of the two processes including casting and spraying, and to become a part of the intended layer stack, an inner layer formed of a high-elastomeric material which reacts with a material-swelling behavior on contact with fuel of the type contained in the container, and (b) thereafter forming, also to become a part of the intended layer stack, outwardly of the surface-applied inner layer relative to the container-wall surface, and also of the same high-elastomeric material used in the applied inner layer, another layer by the other one only of the two, mentioned processes.

In the practice of the methodology of the present invention, spray-formed layers are prepared utilizing sprayable, high-elastomeric material which has been conventionally pre-provided with an appropriate, included “curing accelerator”, whereby substantially full material curing occurs in a matter of just a few seconds. Cast-formed layers, however, which are formed with essentially the same high-elastomeric material, are formed with such material that has, differently, been conventionally pre-provided with an appropriate, included “curing retarder”, whereby substantially full material curing occurs in a matter of about, say, twenty minutes. This attention to differential, material-curing acceleration and material-curing retardation plays an important role in achieving a combined sprayed-on-material/cast-material interfacial joinder which is significant in relation to the intended cooperative ways in which these materials, in juxtaposed layers in a prepared protective coating, collaborate in the intended self-sealing of a liquid leak.

The various features and advantages offered by the present invention will become more fully apparent as the detailed description presented below is read in conjunction with the accompanying drawings.

### DESCRIPTIONS OF THE DRAWINGS

FIG. 1, with portions of what is pictured here broken away to reveal details of internal construction, presents a simplified side elevation of a relatively simple-topography, liquid-fuel container, or tank, the outside surface of the wall in which has been coated with a three-layer (layer stack), anti-fuel-leak, barrier coating structured, and prepared, in accordance with a preferred and best-mode embodiment of, and manner of practicing, the present invention. This three-layer coating, wherein the three layers constitute what is referred to herein as a layer stack includes both cast-formed and spray-formed layers.

As will be explained below, FIG. 1 is employed herein economically, effectively, to illustrate three, different, specific cast/sprayed layer-stack arrangements, one of which includes a pair of cast layers and a single sprayed layer, and the other two of which include, each, a pair of sprayed layers and a single cast layer.

This figure also illustrates a simplified fragment of a representative casting mold usable for casting the cast layers.

FIG. 2 is an enlarged, fragmentary, cross section taken generally along the line 2-2 in FIG. 1.

FIG. 3 is a stylized, fragmentary, cross-sectional, and “visual-story-telling” view, drawn on a scale which lies between those employed in the other two drawing figures, generally illustrating a portion of an unusually shaped fuel container, and layer and coating-application structures and shape circumstances uniquely addressed by the utilization, according to the invention, of cast layers. Accordingly, two, quite different cast layers are shown as pieces of the story-telling aspect of this drawing figure, and the figure also pictures, in respective relation to these two, unique cast layers, simplified fragments of two, different, respectively associated conventional casting molds that are employable for forming these two cast layers.

Components presented in these drawings have not been drawn to scale.

### DETAILED DESCRIPTION OF THE INVENTION

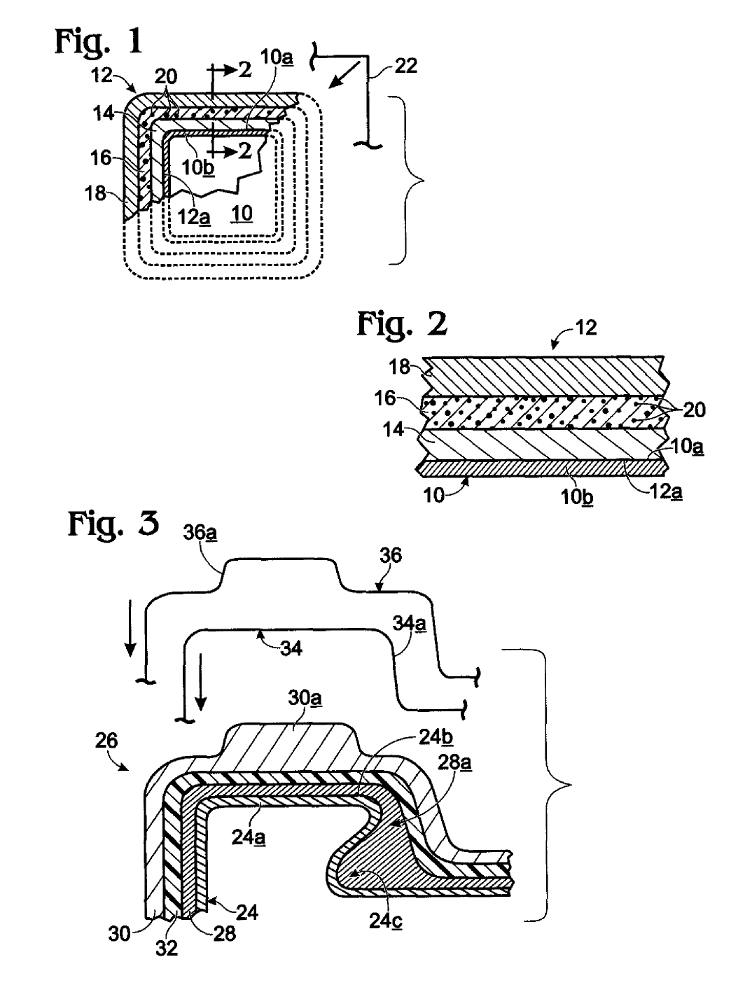

Turning now to the drawings, and referring first of all to FIGS. 1 and 2, indicated generally at 10 is a liquid-fuel container, or tank, in conjunction with which there has been applied to the outside surface 10a of its wall 10b a three-layer (plural-layer), anti-fuel-leak, barrier coating 12, also referred to herein as a barrier-coating layer stack possessing plural, cooperative, contact adjacent layers, formed in accordance with a preferred and best-mode embodiment of, and manner of practicing, the present invention. Coating 12, which includes an inner side 12a, and an outer side 12b, is formed herein specifically, as mentioned, with three layers, including an inner layer 14, an intermediate layer 16, and an outer layer 18. The inner side of inner layer 14, which effectively defines the just-mentioned inner side 12a of coating 12, is disposed directly adjacent and in contact with container wall surface 10a.

While we have determined that, for liquid containers in the category of such containers generally discussed above as being most appropriate for employing cast-formed layers, a three-layer stack of cooperative, anti-leakage, protective layers, including at least one cast-formed layer, and usually at least one spray-formed layer, produces a preferred coating-structure layer count, we appreciate that other plural-layer counts may be employed.

In general terms, each of layers 14, 16, 18 herein is formed principally of a liquid-fuel-reactive, high-elastomeric, a high-tensile-strength, high-tear-resistance, material, and for this material, we have chosen, as a preferred material, the two-compound polyurethane elastomer product sold under the trademark TUFF STUFF®FR, made by Rhino Linings USA, Inc.—a company based in San Diego, Calif. In the preferred embodiment of the invention, layer 14 is a cast-in-place (or cast-formed) layer, layer 16, a spray-applied (or spray-formed) layer, and layer 18, a second, cast-in-place (or cast-formed) layer. Layer 14, in the embodiment of the invention now being described, has a thickness of about 0.250-inches, layer 16, a thickness of about 0.250-inches, and layer 18, a thickness of about 0.250-inches.

Intermediate layer 16 further includes an embedded, or entrained, population of distributed liquid-fuel imbiber beads, such as the beads shown at 20 in FIGS. 1 and 2. Beads 20 herein are made of the product known as IMB230300, produced by Imbibitive Technologies America, Inc. in Midland, Mich. These beads preferably are blended, in any appropriate manner during a layer-creation spraying operation, into the entraining elastomeric material so as to constitute about 20% by weight of the combined material which makes up layer 16.

As mentioned above, with respect to the specific embodiment of the invention which has been described so far, the order of the preferred, three, illustrated coating layers, progressing outwardly from container-wall 10a, is (a) cast-formed, (b) spray-formed, (c) cast-formed. We have determined that, in terms of preparing protective coatings, and, as stated above, preferably three-layer coatings, for most containers that are especially suited for receiving cast-formed layers, this order of layers is the best choice for most applications.

This preferred, “cast-sprayed-cast”, layer order, or arrangement, however, is not the only order of layers which may be implemented in accordance with the invention. Other specific layer orders are selectable, and may be desired in certain applications. As a manner of illustrating this statement, FIGS. 1 and 2 should be visualized at this point briefly as illustrating two, other (than what has been described so far) specific layer arrangements wherein, in one instance, inner layer 14 is a spray-formed layer, intermediate layer 16, a spray-formed layer, and outer layer 18, a cast-formed layer. In a second instance, inner layer 14 is a cast-formed later, intermediate layer 16, still a spray-formed layer, and outer layer 18, a spray-formed layer. Inner, intermediate and outer respective layer thicknesses, mentioned above, may remain the same.

One will note that, in all of these three-described, specifically different layer arrangements, intermediate layer 16 is consistently formed and identified as a spray-created layer. This is so for reasons of practical-utility preference, one of which is that a layer which is spray-formed in nature is particularly receptive to the embedment and incorporation of additional elements, such as liquid-imbiber beads, like beads 20, and another, related one of which is that, in many self-sealing invoking instances, such an intermediately positioned layer is best located in an over-all coating to offer, under puncture-produced leakage conditions, additional, cooperative self-sealing action. During the preparation of such an intermediate layer, and as a part of an intended spray-application, layer-creation process, sprayable high-elastomeric material, made preferably from the product identified above, is prepared for spraying in a manner involving appropriate pre-blending with the pre-applied, sprayable elastomeric material of a suitable-volume flow of beads, whereby the resulting, spray-formed intermediate layer, following spraying, contains the desired, distributed population of beads, as illustrated in FIG. 2, and described above.

In the two, particular, alternative layer arrangements just mentioned above wherein two, spray-formed layers are created, and considering certain aspects involving selections for use of those arrangements, an inner, spray-formed layer might be desired in circumstances associated with including additional elements, such as imbiber beads, especially close to the outside surface of a liquid-container wall, and an outer, spray-formed layer might be desired in circumstances associated with including additional elements, such as imbiber beads, or intumescence particles, or both, close to the outside surface of an entire coating. Intumescence-particle incorporation arms a protective layer to furnish external-fire, and extreme external-heat, protections for a coated container.

Further indicated very simply and schematically in FIG. 1, at 22, is a representative corner fragment of a conventionally constructed casting mold, which may be entirely conventional in construction, and employable (appropriately sized, of course) in the preparation of cast-formed layers 14, 18.

Casting of layers in accordance with practice of the methodology of the present invention, such as the casting of layers 14, 18, as well as the casting of two layers still to be described that are illustrated in FIG. 3, will be explained below herein.

Turning attention now to FIG. 3 in the drawings, indicated fragmentarily and generally at 24 is a portion of an unusual-outside-surface topography, liquid fuel container. Container 24 includes a specially shaped wall 24a having an outside surface 24b, and including, at the location shown at 24c a folded, somewhat underbeveled, curvilinear, convolution, or sinuosity.

As was mentioned above in relation to the descriptions given of the drawing figures, FIG. 3 has been presented herein to illustrate two, particular circumstances in which it is useful to incorporate cast-form layers in a protective, layer-stack coating of the type contemplated by the invention in order to produce both an appropriately precision-outside-shaped, and a fully container-contact-covering, protective, self-sealing, anti-leakage coating on a container having a topographically unusual wall structure, such as that pictured representatively with sinuosity 24c in FIG. 3. Accordingly, not only does FIG. 3 illustrate the construction, and the preparing, of a fully contact-protective coating including a specially formed, inner-cast-material layer on a surface-topographically-unusual liquid container, it also demonstrates the utility of employing a cast-formed outer layer so as to create a very precisely controlled, final, outside topographic configuration for a coated container to prepare it for fitting appropriately into a particular, intended reception space (not specifically shown in FIG. 3).

With regard to the presence of container-wall sinuosity 24c, it will be apparent that there are regions of wall surface 24b disposed within this sinuosity which are clearly shaded from effective spray coating of a protective layer that will completely cover appropriately such wall-surface regions. It is to deal specifically with this issue, as well as to deal with the matter of creating a special, precision-formed outside surface topography, that the three-layer, layer-stack coating, which is pictured generally at 26 in FIG. 3, includes specifically cast-formed inner and outer layers 28, 30, respectively, between which resides an intermediate, spray-formed layer 32.

As can be seen, cast-formed inner layer 28 is one which completely contacts outside wall surface 24b in container 24, and specifically, completely fills the curvilinear region, or zone, defined by sinuosity 24c. This inner layer is formed during casting via, for example, a conventional casting mold 34 having a specially shaped portion like that shown fragmentarily at 34a designed so that when casting of this layer takes place, mold material will flow into unusual topographic irregularities, such as sinuosity 24c, and possess, outwardly at such a location, an outside, cast-formed portion, such as that indicated generally at 28a, having a surface configuration which possesses a “non-shaded” exposure that lends itself to adequate coating by a subsequently spray-applied layer, such as intermediate layer 32.

Accordingly, following cast-forming of inner layer 28 as described, spray-formed intermediate layer 32 is easily applied in a manner whereby this layer completely covers the exposed surface area of the inner, cast-formed layer, as shown.

Thus one can readily see and understand how the implementation of cast-forming, in accordance with practice of the present invention, enables production of an inner layer in a plural-layer coating of the type contemplated by the invention which is capable, as is desired, of forming a complete contactive layer-coating for the outside surface of a container having unusual, and difficult-to-spray-adequately, topographic features, such as container-wall sinuosity 24c.

Continuing further with what appears in FIG. 3, as was also mentioned above herein, this figure illustrates how cast-forming readily accommodates the creation, where desired, of an outer, cast-formed, protective-coating layer, such as outer layer 30 in coating 26, having in its finished state a particular, precision outside topography, or configuration. In the illustration presented in this figure, the finished, completely coated container 24 is intended to have, as an integrated and fully coated structure ready for installation, an outward projection, such as the projection generally shown in outer layer 30 at 30a in FIG. 3, in order to have a predetermined, precise shape in its outer surface so as to fit designedly correctly in its intended installation-reception space. Projection 30a, on will note, does not follow the “underlying” surface shape of wall 24a.

Here, cast-forming of outer layer 30, utilizing an appropriately shaped conventional casting mold, a fragmentary portion of which is shown generally at 36, accomplishes this readily. As can be seen, mold 36 includes a specially shaped portion 36a which is designed specifically, during cast-forming of outer layer 30, to create layer projection 30a.

As has been explained above, the present invention contemplates certain fabrication methodology linked to the end-result container coating layers that have been described. This methodology specifically features a method for creating an anti-fuel-leak, plural-layer-stack barrier coating on the outside surface of the wall in a liquid-fuel container. It includes the steps of (a) applying directly onto such a surface, by one only of the two processes including casting and spraying, and to become a part of the intended layer stack, an inner layer formed of a high-elastomeric material which reacts with a material-swelling behavior on contact with fuel of the type contained in the container, and (b) thereafter forming, also to become a part of the intended layer stack, outwardly of the surface-applied inner layer relative to the container-wall surface, and also of the same high-elastomeric material used in the applied inner layer, another layer by the other one only of the two processes.

The method of the invention also includes spray-incorporating a flow of liquid-fuel imbiber beads into certain spray-applied layers.

In terms of implementing the methodology of the invention regarding the creations of both spray-formed and cast-formed layers in an overall coating layer stack, with respect to whichever coating is the one which is to be applied as the inner coating directly to the outside surface of a liquid container, where appropriate to enhance initial-layer bonding, that container surface may, at first, be prepared with appropriate surface abrasion, and/or with any appropriate bonding-promoting primer material recommended by the manufacturer of the particular elastomeric material which is to be applied, such as the specific elastomeric material mentioned above herein.

Additionally, and with specific reference to subsequent layer-stack creation, and the associated spray-formation and casting-formation of layers, appropriate spraying and casting steps, also recommended by the manufacturer of the layer-stack-common elastomeric material which is to be employed will preferably be followed. In order to obtain excellent inter-layer bonding, it may be appropriate, and this is an entirely conventional process, to incorporate into the spray-forming and the cast-forming materials, per se, a plastic-resin-curing accelerator or retarder, as deemed appropriate, whereby one may achieve, with respect to a surface which is about to receive the next-applied layer, a condition of not-quite-complete curing so as to enable robust, inter-layer bonding in the interfacial regions between adjacent layers. The present invention is not specifically concerned with such curing acceleration/retardation practices, but merely “appreciates” that these kinds of practices may be useful in certain instances to achieve user-desired, inter-layer bonding.

Accordingly, preferred and best-mode embodiments of, and manners of practicing, the present invention have been described and illustrated herein, with certain variations and modifications suggested. In this setting, we appreciate that those skilled in the art reading and understanding the present invention in relation to the included disclosure content may well determine that there are other useful variations and modifications of the invention which they wish to employ, and it is our intention that all such other variations and modifications will be deemed to come within the scopes of the appended claims to invention.

We claim:

1. An anti-fuel-leak, plural-layer barrier coating applicable to the outside surface of the wall in a liquid-fuel container, said coating, in operative condition relative to such a surface, comprising
a layer stack including plural, cooperating, barrier layers, each formed of a high-elastomeric material which reacts with a material-swelling behavior on contact with fuel of the type contained in the container, and, among said layers,
at least one cast-formed layer.

2. An anti-fuel-leak, plural-layer barrier coating applicable to the outside surface of the wall in a liquid-fuel container, said coating, in operative condition relative to such a surface, comprising
a layer stack including plural, cooperating, barrier layers, each formed of a high-elastomeric material which reacts with a material-swelling behavior on contact with fuel of the type contained in the container, and, among said layers,
at least one cast-formed layer, and
at least one spray-formed,
one of said two, at-least-one layers being an inner layer disposed directly against the mentioned container-wall surface, and the other layer being an outer layer disposed outwardly of the inner layer relative to the container wall surface.

3. The coating of claim 2, wherein the inner layer is the cast-formed layer.

4. The coating of claim 2, wherein the inner layer is the spray-formed layer.

5. The coating of claim 2, wherein the at least one spray-formed layer includes a population of distributed liquid-fuel imbiber beads.

6. An anti-fuel-leak, plural-layer barrier coating having an inner side applicable to the outside surface of the wall in a liquid-fuel container, and an outer side, said coating, in operative condition relative to such a surface, comprising
cooperating, contact-adjacent layers, three in number, organized in at least one of the following manners, progressing from the inner side toward the outer side of the coating,
(a) cast-formed, spray-formed, cast-formed,
(b) spray-formed, spray-formed, cast-formed, and
(c) cast-formed, spray-formed, spray-formed.

7. A method for creating an anti-fuel-leak, plural-layer-stack barrier coating on the outside surface of the wall in a liquid-fuel container comprising
applying directly onto such a surface, by one only of the two processes including casting and spraying, and to become a part of the intended layer stack, an inner layer formed of a high-elastomeric material which reacts with a material-swelling behavior on contact with fuel of the type contained in the container, and
thereafter forming, also to become a part of the intended layer stack, outwardly of the surface-applied inner layer relative to the container-wall surface, and also of the same high-elastomeric material used in the applied inner layer, another layer by the other one only of the two processes.

8. The method of claim 7, wherein the mentioned one process is casting.

9. The method of claim 8, wherein forming of the mentioned other layer takes place to produce direct contact between it and the applied inner layer

10. The method of claim 7, wherein the mentioned one process is spraying.

11. The method of claim 10, wherein the mentioned one process includes spray-incorporating a flow of liquid-fuel imbiber beads.
